(19) United States
(12) Patent Application Publication
(10) Pub. No.: US 2014/0055389 A1
(43) Pub. Date: Feb. 27, 2014

(54) REDUCING THE NUMBER OF SIGNALS NEEDED FOR OPERATING A TOUCH SENSITIVE DEVICE

(71) Applicant: Cirque Corporation, Salt Lake City, UT (US)

(72) Inventor: Keith L. Paulsen, Centerville, UT (US)

(73) Assignee: Cirque Corporation, Salt Lake City, UT (US)

(21) Appl. No.: 13/972,692

(22) Filed: Aug. 21, 2013

Related U.S. Application Data
(60) Provisional application No. 61/691,486, filed on Aug. 21, 2012.

(51) Int. Cl. G06F 3/041

(52) U.S. Cl. CPC G06F 3/041
USPC 345/173

(57) ABSTRACT

A system and method for reducing the number of transmit and receive signals that are necessary to operate a touch sensitive device having a sensing area comprised of an orthogonal electrode grid, a controller chip being capable of grouping together various electrodes when driving and reading signals from the touch sensitive device, or using the same number of drive pins and sense inputs to operate a much larger touch sensitive device.

### BACKGROUND OF THE INVENTION

1. Field of the Invention

This invention relates generally to touch sensors. More specifically, the present invention is a system and method for reducing the number of drive and sense lines that are needed to operate a touch sensitive device.

2. Description of Related Art

Hereinafter, references to a touchpad shall include all touch sensitive surfaces including touchpads, touch screens and touch panels. There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE™ Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

The touchpad described above uses a single controller IC having a limited number of input pins for receiving signals from the X, Y and sense electrodes. The finite number of pins has meant that the largest area of a touchpad was determined by the spacing between X and Y electrodes. Thus, it would be an advantage to use a standard controller IC but increase the usable area of a touchpad without having to increase the spacing between electrodes or use a more costly controller IC with more input pins.

### BRIEF SUMMARY OF THE INVENTION

The present invention is a system and method for reducing the number of transmit and receive signals that are necessary to operate a touch sensitive device having a sensing area comprised of an orthogonal electrode grid, a controller chip being capable of grouping together various electrodes when driving and reading signals from the touch sensitive device, or using the same number of drive pins and sense inputs to operate a much larger touch sensitive device.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

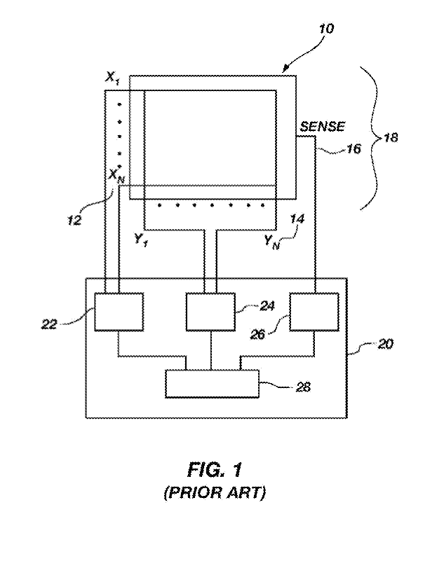

FIG. 2 is a block diagram that shows how a prior art touchpad having a one-to-one correspondence between sense input pins and sense electrodes, and drive output pins and drive electrodes.

FIG. 3 is a block diagram that shows how the drive output pins of a controller integrated circuit are modified within the controller when driving electrodes of the touchpad.

FIG. 4 is a block diagram that shows how the sense input pins of a controller integrated circuit are modified within the controller when sensing electrodes of the touchpad.

FIG. 5 is a block diagram that shows how the drive output and the sense input pins of a controller integrated circuit are modified within the controller when driving and sensing the electrodes of the touchpad.

FIG. 6 is a block diagram that shows how to drive a larger touchpad if the sense input pins and the drive output pins are both modified.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensitive device” throughout this document may be used interchangeably with “touch sensor”, “capacitive touch sensor device”, “touchpad”, “touch panel”, and “touch screen”.

A touch sensitive device is operated using a controller integrated circuit to provide drive signals to and for receiving sense signals from an electrode grid. In the prior art, there is a one-to-one correspondence of drive output pins of a controller and drive electrodes on the electrode grid, and sense input pins of a controller and sense electrodes on the electrode grid. The present invention is an improvement on this design by reducing the number of drive output pins and sense input pins and thus the drive signals and sense inputs that are needed to operate an electrode grid of a touchpad or other touch sensitive device.

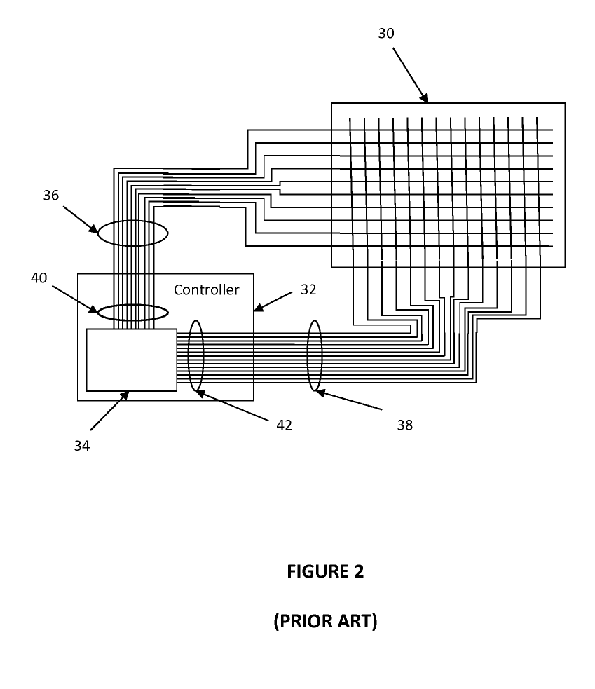

For example, consider the electrode grid of a touchpad 30 as shown in FIG. 2. The touchpad 30 includes a sensing area comprised of orthogonal electrodes forming an X and Y electrode grid. The number of X and Y (drive and sense) electrodes shown are for illustration purposes only and should not be considered to be limiting.

A controller integrated circuit 32, or “controller” hereinafter, includes a driving and sensing circuit 34 that generates drive signals that are transmitted from drive output pins 42 to a first group of electrodes that are designated as drive electrodes 38, and sense input pins 40 that receive input from a second group of electrodes that are designated as sense electrodes 36. The driving and sensing circuit 34 may be capable of switching the function of any input or output pins 40, 42, or the function of the pins may be dedicated. Therefore, the assignment of drive and sense electrodes 36, 38 is arbitrary and may be switched as desired.

FIG. 2 illustrates the concept that the prior art teaches a one-to-one correspondence between the number of sense input pins 40 and the number of sense electrodes 36, and the number of drive output pins 42 and the number of drive electrodes 38.

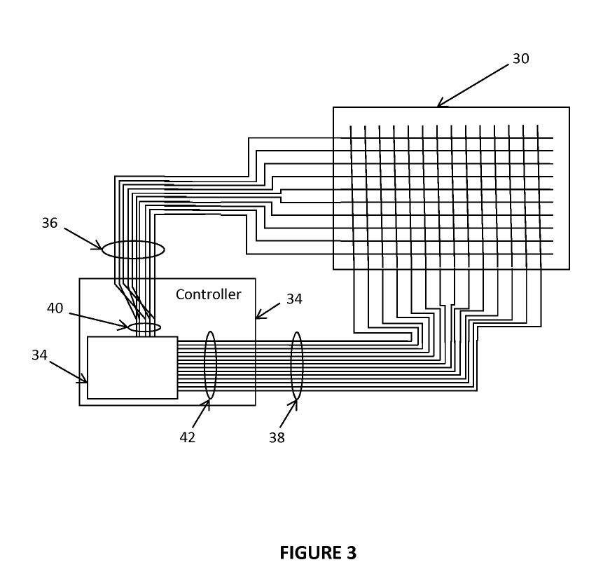

FIG. 3 is provided as a first embodiment of the present invention. In FIG. 3, the number of sense electrodes 36 of the touchpad 30 may remain the same, but the number of sense input pins 40 may be changed. In this first embodiment, each of the sense input pins 40 of the driving and sensing circuit 34 receives input from two different sense electrodes 36. In contrast, there is still a one-to-one correspondence of drive output pins 42 and drive electrodes 38.

Existing analysis of the input from the sense electrodes 36 is able to determine the location of an object or objects on the touchpad 30. What is important is that the driving and sensing circuit 34 is able to use half the number of sense input pins 40 for the same number of sense electrodes as compared to the prior art.

One aspect of this first embodiment is that a controller 32 can be used that has a fewer number of sense input pins 40, thus reducing the cost of the controller that is needed for a given number of sense electrodes 36.

Another result of the first embodiment is that if the same number of sense input pins 40 are provided as in FIG. 2, then a larger touchpad can be operated by the controller 32. The touchpad may have twice as many sense electrodes for the same controller 32.

The means by which the controller 32 is able to reconfigure connections between the drive output pins 42 and the drive electrodes 38, and between the sense input pins 40 and the sense electrodes 36, is not considered to be an element of the present invention. These connections can be made by any convenient method that is commonly used to dynamically switch connections between electrodes, and for connection multiple electrodes to a single electrode. However, it may be the fact that the connections are being made dynamically, and are being made within the controller instead of having to hard-wire the changes on the touchpad 30, that should be considered as elements of the present invention.

Another aspect of the first embodiment is that the sense input pins 40 of the driving and sensing circuit 34 may receive input from more than two different sense electrodes 36. In other words, the sense input pins 40 may receive input from three or more different sense electrodes 36. By controlling the timing of the signals being received by the sense input pins 40, many sets of sense electrodes 36 may share the sense input pins 40. In an alternative embodiment, signals may be demultiplexed into the sense input pins to thereby enable many different sets of sense electrodes 36 to send signals to the sense input pins 40. A demultiplexing circuit may be incorporated into the controller 34, may be disposed before the signals are sent to the controller from the sense electrodes 36, or it may be disposed within the driving and sensing circuit 34.

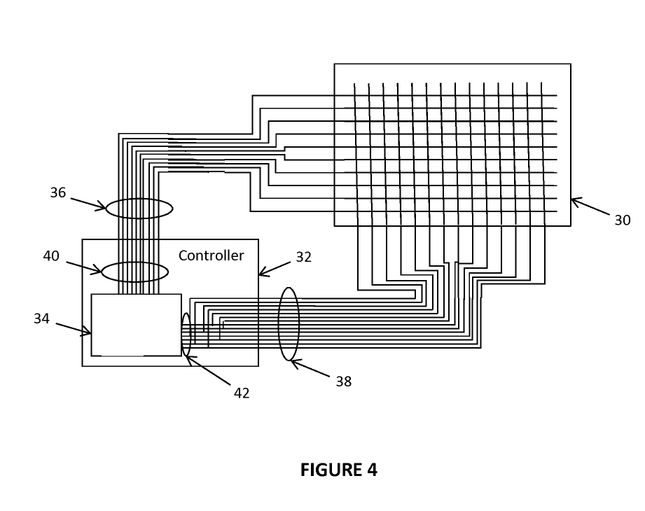

FIG. 4 is provided as a second embodiment of the present invention. In FIG. 4, the number of drive electrodes 38 of the touchpad 30 remains the same for a fewer number of drive output pins 42. In this second embodiment, each of the drive output pins 42 of the driving and sensing circuit 34 transmits a drive signal onto two different drive electrodes 38. In contrast, there is still a one-to-one correspondence of sense input pins 40 and sense electrodes 36.

An important aspect of this second embodiment is that the driving and sensing circuit 34 is able to use half the number of drive output pins 42 for a larger number of drive electrodes as compared to the prior art.

One result of this second embodiment is that a controller 32 can be used that has a fewer number of drive output pins 42, thus reducing the cost of the controller that is needed for a given number of drive electrodes 38.

Another result of the second embodiment is that if the same number of drive output pins 42 are provided as in FIG. 2, then a larger touchpad can be operated by the controller 32. The touchpad may have twice as many drive electrodes for the same controller 32.

In another aspect of the second embodiment, each one of the drive output pins 42 of the driving and sensing circuit 34 may transmit a signal to more than two different drive electrodes 38. In other words, the drive electrodes 38 may receive a signal from three or more different drive output pins 42. One method for performing this task may be by controlling the timing of the signals being transmitted by the drive output pins 42. In this way, many sets of drive electrodes 38 may share the drive output pins 42. In an alternative embodiment, signals may be multiplexed onto the drive electrodes 38 to thereby enable many different sets of drive electrodes 38 to receive signals from the drive output pins 42. A multiplexing circuit may be incorporated into the controller 34, may be disposed before the signals are transmitted from the controller to the drive electrodes 38, or it may be disposed within the driving and sensing circuit 34.

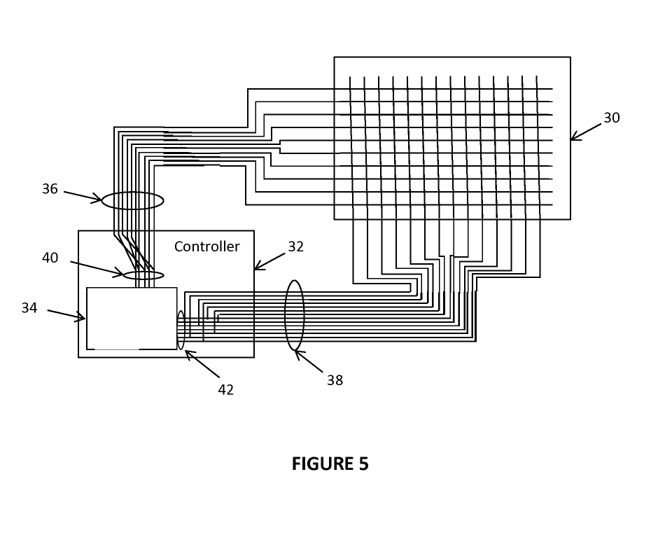

FIG. 5 is provided as another embodiment of the present invention. In FIG. 5, the number of sense electrodes 36 and drive electrodes 38 of the touchpad 30 remains the same, but the number of drive sense input pins 40 and drive output pins 42 may be decreased. In this third embodiment, each of the drive output pins 42 of the driving and sensing circuit 34 transmits a drive signal onto two different drive electrodes 38, and each of the sense input pins 40 receives input from two different sense electrodes 36.

An important aspect of this third embodiment is that the driving and sensing circuit 34 is able to use half the number of drive output pins 42 and half the number of sense input pins 40 for a given number of drive and sense electrodes as compared to the prior art.

One result of this third embodiment is that a controller 32 can be used that has a fewer number of drive output pins 42 and sense input pins 40, thus reducing the cost of the controller that is needed for a given number of drive electrodes 38 and sense electrodes 36.

In other embodiment, multiples sets of sense electrodes 36 and drive electrodes 38 may be coupled to the sense input pins 40 and the drive output pins 42, thereby creating a much larger touchpad. In other words, the sense input pins 40 are now coupled to more than just two sets of sense electrodes 36, and the drive output pins 42 are coupled to more than just two sets of drive electrodes 38. Any number of sets of electrodes may be coupled to the sense input pins 40 and the drive output pins 42.

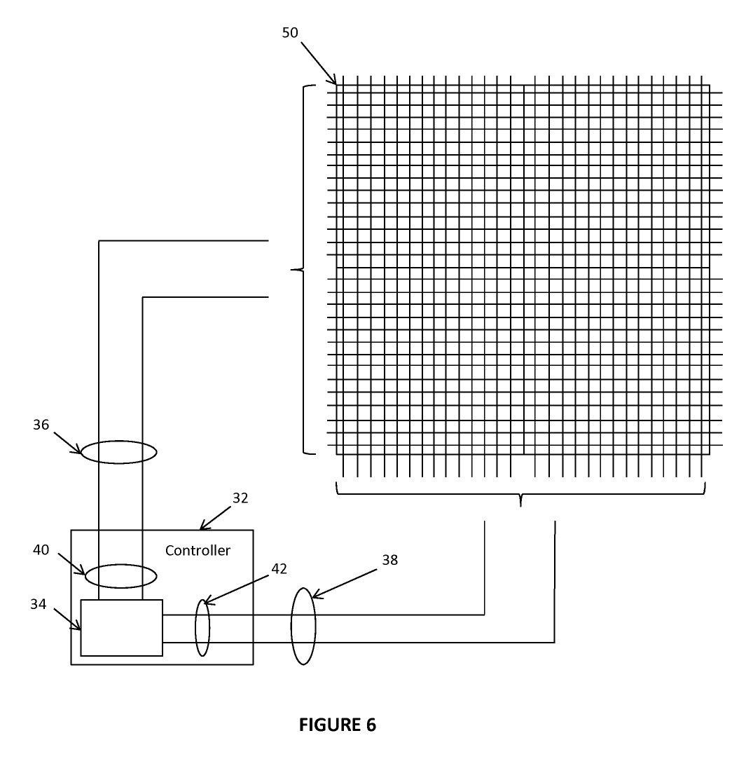

FIG. 6 shows that another aspect of the third embodiment is that if the same number of drive output pins 42 and the same number of sense input pins 40 are provided as in FIG. 2, then a larger touchpad 50 can be operated by the controller 32. The touchpad 50 may have twice as many drive electrodes 38 and twice as many sense electrodes 36 for the same controller 32. Thus, the touchpad 50 may be four times as large as the touchpad 30.

It should be understood that FIG. 6 is for illustration purposes only, and the exact number of drive and sense electrodes may vary. What is being illustrated is that the touchpad 50 is essentially comprised of a touchpad that is four times the area of touchpad 30. However, increasing the number of sets of sense electrodes 36 and drive electrodes 38, the size of the touchpad may be substantially increased.

One of the advantages of the present invention is that instead of making permanent and difficult modifications to the drive and sense electrodes of a touchpad, it is the controller 32 that makes all of the adjustments. The controller 32 may also be dynamically capable of making the adjustments, and thus be adaptable to touchpads having a variety of different numbers of drive and sense electrodes.

Another aspect of the invention is that the controller may be dynamically configurable so as to combine or short together more than just two drive electrodes or two sense electrodes together in the controller. Accordingly, all or just a select few of the sense electrodes may be shorted together to form a single sense electrode. In an alternative embodiment, the drive output pins may be coupled to two or more different drive electrodes.

Another aspect of the present invention relates to proximity sensing. The touch sensitive device of the present invention may also be capable of performing proximity sensing using the same or different circuits and electrode grid. Nevertheless, it is another aspect of the invention that the touch sensitive device may also detect the approach of a detectable object before it makes contact with the touch sensitive device.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for decreasing the number of sense input pins needed to receive signals from a touch sensitive device, said method comprising:
providing a touch sensitive device having a touch sensitive area comprised of a plurality of drive electrodes that are co-planar and orthogonal to a plurality of sense electrodes;
providing a controller that includes a driving and sensing circuit having drive output pins and sense input pins, wherein the drive output pins are coupled to the plurality of drive electrodes, and wherein the sense input pins are coupled to the plurality of sense electrodes; and
configuring the controller such that each of the plurality of sense electrodes is coupled to only one of the sense input pins, while each of the sense input pins is also coupled to more than one of the plurality of sense electrodes, but only one at a time.

2. The method as defined in claim 1 wherein the method further comprises including a demultiplexing circuit in the controller such that only one of the plurality of sense electrodes is coupled to each of the sense input pins at any one time.

3. The method as defined in claim 1 wherein the method further comprises determining a location of an object that is in contact with the touch sensitive area.

4. The method as defined in claim 1 wherein the method further comprises selecting the touch sensitive device from the group of touch sensitive devices comprised of a touchpad, a touch panel and a touch screens.

5. The method as defined in claim 1 wherein the method further comprises including proximity sensing abilities in the touch sensitive device, to thereby enable the touch sensitive device to sense the approach of a detectable object before the object makes contact with the touch sensitive device.

6. A method for decreasing the number of drive output pins needed to drive signals to a touch sensitive device, said method comprising:
providing a touch sensitive device having a touch sensitive area comprised of a plurality of drive electrodes that are co-planar and orthogonal to a plurality of sense electrodes;
providing a controller that includes a driving and sensing circuit having drive output pins and sense input pins, wherein the drive output pins are coupled to the plurality of drive electrodes, and wherein the sense input pins are coupled to the plurality of sense electrodes; and
configuring the controller such that each of the plurality of drive electrodes is coupled to only one of the drive output pins, while each of the drive output pins is also coupled to more than one of the plurality of drive electrodes, but only one at a time.

7. The method as defined in claim 6 wherein the method further comprises including a multiplexing circuit in the controller such that each of the plurality of drive output pins is coupled to more than one of the plurality of drive electrodes, but only one at a time.

8. The method as defined in claim 6 wherein the method further comprises determining a location of an object that is in contact with the touch sensitive area.

9. The method as defined in claim 6 wherein the method further comprises selecting the touch sensitive device from the group of touch sensitive devices comprised of a touchpad, a touch panel and a touch screen.

10. The method as defined in claim 6 wherein the method further comprises including proximity sensing abilities in the touch sensitive device, to thereby enable the touch sensitive device to sense the approach of a detectable object before the object makes contact with the touch sensitive device.

11. A method for decreasing the number of sense input pins needed to receive signals from a touch sensitive device and for decreasing the number of drive output pins needed to drive signals to the touch sensitive device, said method comprising:
providing a touch sensitive device having a touch sensitive area comprised of a plurality of drive electrodes that are co-planar and orthogonal to a plurality of sense electrodes;
providing a controller that includes a driving and sensing circuit having drive output pins and sense input pins, wherein the drive output pins are coupled to the plurality of drive electrodes, and wherein the sense input pins are coupled to the plurality of sense electrodes;
configuring the controller such that each of the plurality of sense electrodes is coupled to only one of the sense input pins, while each of the sense input pins is also coupled to more than one of the plurality of sense electrodes, but only one at a time; and
configuring the controller such that each of the plurality of drive electrodes is coupled to only one of the drive output pins, while each of the drive output pins is also coupled to more than one of the plurality of drive electrodes, but only one at a time.

12. The method as defined in claim 11 wherein the method further comprises:
including a multiplexing circuit in the controller such that each of the plurality of drive output pins is coupled to more than one of the plurality of drive electrodes, but only one at a time; and
including a demultiplexing circuit in the controller such that only one of the plurality of sense electrodes is coupled to each of the sense input pins at any one time.

13. The method as defined in claim 11 wherein the method further comprises determining a location of an object that is in contact with the touch sensitive area.

14. The method as defined in claim 11 wherein the method further comprises selecting the touch sensitive device from the group of touch sensitive devices comprised of a touchpad, a touch panel and a touch screen.

15. The method as defined in claim 6 wherein the method further comprises including proximity sensing abilities in the touch sensitive device, to thereby enable the touch sensitive device to sense the approach of a detectable object before the object makes contact with the touch sensitive device.

16. A system for decreasing the number of sense input pins needed to receive signals from a touch sensitive device and for decreasing the number of drive output pins needed to drive signals to the touch sensitive device, said system comprised of:
a touch sensitive device having a touch sensitive area comprised of a plurality of drive electrodes that are co-planar and orthogonal to a plurality of sense electrodes;
a controller that includes a driving and sensing circuit having drive output pins and sense input pins, wherein the drive output pins are coupled to the plurality of drive electrodes, and wherein the sense input pins are coupled to the plurality of sense electrodes;
configuring the controller such that each of the plurality of sense electrodes is coupled to only one of the sense input pins, while each of the sense input pins is also coupled to more than one of the plurality of sense electrodes, but only one at a time; and
configuring the controller such that each of the plurality of drive electrodes is coupled to only one of the drive output pins, while each of the drive output pins is also coupled to more than one of the plurality of drive electrodes, but only one at a time.

17. The system as defined in claim 16 wherein the system is further comprised of selecting the touch sensitive device from the group of touch sensitive devices comprised of a touchpad, a touch panel and a touch screen.

18. The system as defined in claim 16 wherein the system is further comprised of including proximity sensing circuitry in the touch sensitive device, to thereby enable the touch sensitive device to sense the approach of a detectable object before the object makes contact with the touch sensitive device.
